(19) United States
(12) Patent Application Publication
(10) Pub. No.: US 2012/0262050 A1
(43) Pub. Date: Oct. 18, 2012

(54) Type of Led Light

(76) Inventor: Szu Min Fan, Markham (CA)

(21) Appl. No.: 13/087,941

(22) Filed: Apr. 15, 2011

(51) Int. Cl. H01J 5/00

(52) U.S. Cl. 313/317

(57) ABSTRACT

This is an LED light, which contains the housing and the socket that is built in the housing. The socket is equipped with at least 3 LED luminotrons. Compared with the LED lights that have only 1 or 2 LED luminotrons, this light is more powerful in its intensity of light. Along the inside walls of the housing describled above there are at least 2 symmetric prisms, which reflect and refract the light that the LED luminotrons give out to increase the rays coverage, and consequently, to expand the illumination zone. And diamond-shaped fringes are evenly distributed on the outside walls of the housing will be further refracted by the diamond-shaped fringes and produce viewing glare for better visual effects.

### FIELD OF THE DESIGN

This design is a type of light, to be more specific, a type of LED light.

### BACKGROUND OF THE DESIGN

The LED lights found on current market usually have only 1 or 2 LED luminotrons built inside. The intensity of light is usually limited, far from satisfying the demand to be used in a larger space. And moreover, the structure of the traditional LED lights is usually simple and the visual effect is not good enough.

### CONTENTS OF THE DESIGN

To solve the technical problem this design is to offer a gas discharge lamp controller that is precise in movement time so as to act exactly when the alternating current power supply passes zero.

To solve the above-mentioned problem, this design adopts the following technical solutions:

An LED light, which includes the housing and also the socket, built in the housing. This socket is equipped with at least 3 LED luminotrons and along the inside walls of the housing described above there are at least 2 symmetric prisms and diamond-shaped fringes are evenly distributed on the outside walls of the housing.

Advantageously, the transparent cover is set for the outside of the housing.

Advantageously, there are 3 prisms and 3 LED luminotrons, set toward the 3 prisms respectively.

Advantageously, the inside walls of the housing are cylindrical, the prisms set toward the generatrix of the inside walls of the housing and the diamond-shaped fringes set toward the generatrix of the outside walls of the housing.

Advantageously, the sections of the prisms are circular, trapezoidal or triangular, and the housing cone-shaped.

The advantageous effects of this design are: a type of LED light, including the housing and the socket built in the housing. The socket is equipped with at least 3 LED luminotrons. Compared with the LED lights with 1 or 2 LED luminotrons, its intensity of light is much more enhanced. Along the inside walls of the housing there are at least 2 prisms symmetrically distributed and the rays given out from the LED luminotrons are reflected and refracted through the prisms, producing larger coverage of rays, therefore, the illumination zone is expanded. And diamond-shaped fringes are evenly distributed along the outside walls of the housing. The rays reflected and refracted by the prisms of the inside walls of the housing are further refracted by the above-mentioned diamond-shaped fringes and viewing glare is created for better visual effects.

### DRAWINGS

FIG. 1 is the external structural sketch of the design of this LED light;

FIG. 2 is the bottom view of the design of this LED light;

FIG. 3 is an A-A sectional view of FIG. 1.

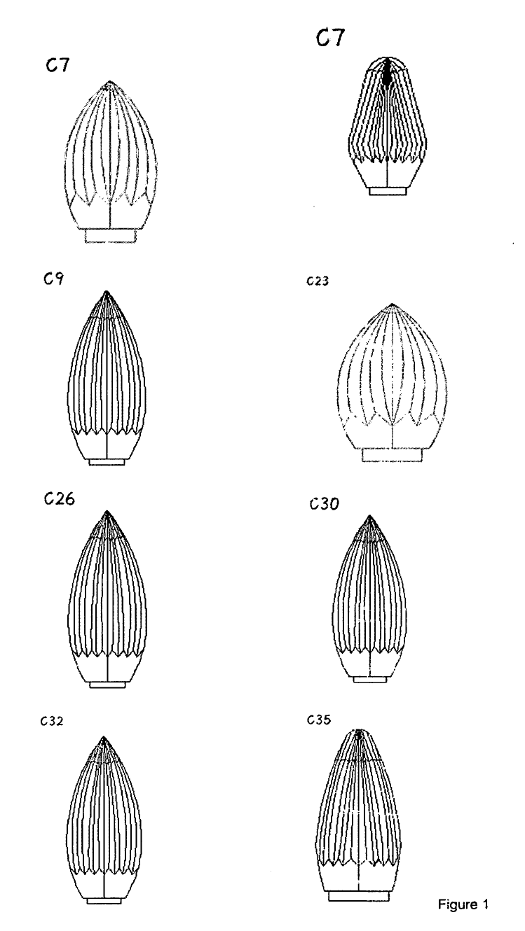

In the figures 1 represents the housing, 2 socket, 3 prisms and 4 diamond-shaped fringes.

### Embodiment

The present design will now be further described by referring to the accompanying drawings that illustrate the advantageous embodiments of this design, from which its objects and features will be evident.

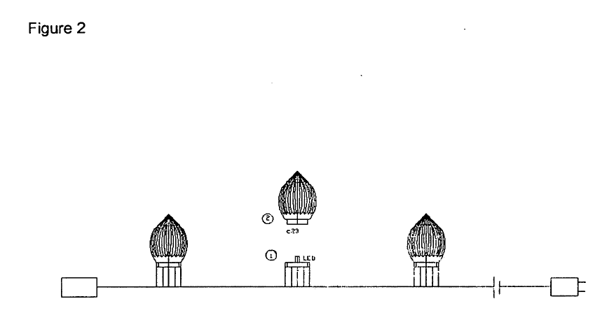

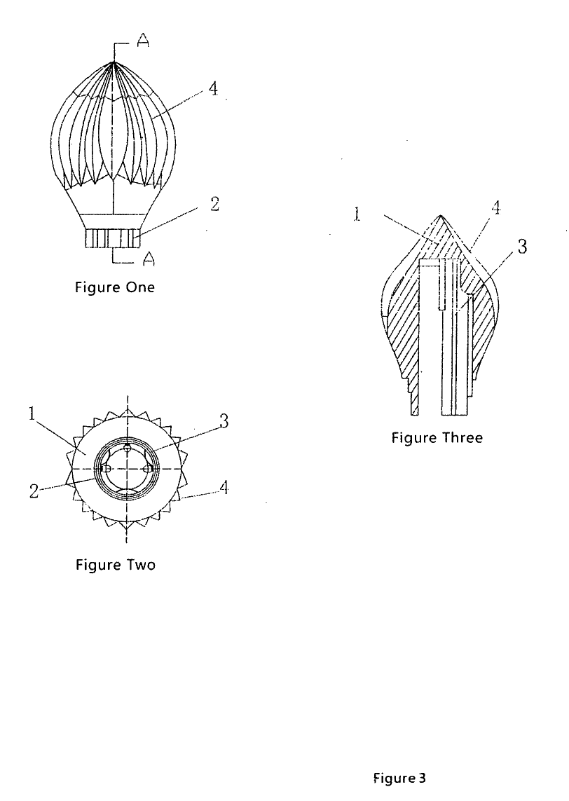

As seen in FIGS. 1, 2 and 3, this is an LED light, including housing 1, and socket 2 built in housing 1. This socket 2 is equipped with at least 3 LED luminotrons (not shown in the Figures). Compared with average LED lights with 1 or 2 LED luminotrons, the intensity of light of this design is much enhanced. Along the inside walls of the housing 1 described above there are at least 2 symmetric prisms 3, which reflect and refract the light that the above-mentioned LED luminotrons give out to increase the rays coverage, and consequently, to expand the illumination zone. And diamond-shaped fringes 4 are evenly distributed on the outside walls of the housing 1. The rays reflected and refracted through the prisms 3 of the inside walls of the housing 1 will be further refracted through the diamond-shaped fringes 4 and produce viewing glare for better visual effects. And Led luminotrons of different colours can be introduced into it to produce colourful lights for decoration and beautification. The outside of the housing is designed with a transparent cover (not shown in the Figures) to protect the housing 1 and LED luminotrons.

Advantageously, there are 3 LED luminotrons in this design. This intensity of light will meet the needs of average household for electricity and moreover, the price is relatively low, therefore, this design is also cost effective. And of course, 4 or 5 LED luminotrons can also be used.

There are 3 prisms 3 in this design and the LED luminotrons are set toward the 3 prisms 3 respectively. And of course, the number of prisms 3 can be as many as 3, 4, or 5.

Advantageously, the inside walls of housing 1 is cylindrical; the prisms 3 are set toward the generatrix of the inside walls of the housing 1 and the diamond-shaped fringes 4 set toward the generatrix of the outside walls of the housing 1. The sections of the prisms 3 can be circular, trapezoidal or triangular, and the housing 1 is cone-shaped. This can be designed into different shapes according to different taste.

While the design has been described with reference to exemplary embodiments, it will be understood by those skilled in the art that various changes may be made and equivalents may be substituted for elements thereof without departing from the scope of the design. In addition, many modifications may be made to adapt a particular situation to the specifications of the design without departing from the essential scope thereof. Therefore, it is intended that the design not be limited to the particular embodiments for carrying out this design, but that the design will include all embodiments falling within the scope of the appended claims.

1. An LED light, with the housing included. It is featured by the socket built in the housing, the socket equipped with at least 3 LED luminotrons and at least 2 symmetric prisms along the inside walls of the housing while diamond-shaped fringes evenly distributed on the outside walls of the housing.

2. The LED light as claimed in claim 1 is featured by a transparent cover for the outside walls of the housing.

3. The LED light as claimed in claim 1 and 2 is featured by 3 prisms, 3 LED luminotrons mentioned above and the 3 LED luminotrons all set toward the 3 prisms respectively.

4. The LED light as claimed in claim 1 and 2 is featured by the cylindrical inside walls of the housing, the prisms set toward the generatrix of the inside walls of the housing and the diamond-shaped fringes set toward the generatrix of the outside walls of the housing described above.

5. The LED light as claimed in claim 1 and 2 is featured by the sections of the above-mentioned prisms being circular, trapezoidal or triangular, and the above-mentioned housing being cone-shaped.
